(19) United States
(12) Patent Application Publication
(10) Pub. No.: US 2026/0089292 A1
(43) Pub. Date: Mar. 26, 2026

(54) SYSTEM FOR ORGANIZING, MANAGING, RUNNING AND SCORING PERSON-TO-PERSON OR REMOTE MEETINGS

(71) Applicant: ECONIQ LIMITED, Galway (IE)

(72) Inventors: Stephen RYAN, Galway (IE); James CALLAN, Galway (IE)

(73) Assignee: ECONIQ LIMITED, Galway (IE)

(21) Appl. No.: 19/338,451

(22) Filed: Sep. 24, 2025

(30) Foreign Application Priority Data
Sep. 25, 2024 (EP) 24202487.5

(51) Int. Cl. H04N 7/15; G06F 9/54

(52) U.S. Cl. CPC H04N 7/155; G06F 9/542

(57) ABSTRACT

A meetings hub engine system takes an input of predefined sequences of meetings which defines each meeting including linked objects including conversation starters. The system can automatically score each meeting for meeting quality based on the coverage of the meeting to the defined input and scoring quality definition. The system is also capable of injecting new agenda and topics before the start of a meeting, if required to be discussed by the advisor and client. The engine generates a recording of the meeting and also actions based on the events triggered during the meeting. A synchronization server follows in real-time a first party's instance of the meetings hub engine that is actively running a meeting. An unstructured data interpreter interprets unstructured text in communications between parties and automatically converts this unstructured data into a structured meeting definition.

### INTRODUCTION

The present invention relates to systems with data processors and communication interfaces for managing meetings.

It is common practice for financial advisors to meet either face to face or remotely using remote screen-sharing and visual/audio software like Zoom™, Microsoft Teams™ or Cisco WebEx™ with their potential prospects or clients. They often use applications like Microsoft Powerpoint™ or Apple Keynote™ to present information to their clients in these meetings.

It is known to provide meeting management systems, and an example is described in US2024/0259446 (Stretch Meetings Inc.).

U.S. Pat. No. 10,832,223B2 (Microsoft Technology Licensing, LLC; Intel Corporation) describes an automatic remote communications session creation for remote meetings and the setup of meeting object that relates to meeting resources such as server resources, voice lines, and other communication resources may need to be scheduled in advance.

U.S. Pat. No. 11,689,381B1 (Microsoft Technology Licensing, LLC) describes a system for calculating meeting inclusion metrics including insights and recommendations. Meeting data associated with one or more meetings attended by at least one participant remotely is converted into anonymized meeting data for inclusivity metric analysis.

US2014129576A1 (INTERNATIONAL BUSINESS MACHINES CORP) describes a method, computer program product, and computer system for analysis of meeting content and agendas.

U.S. Pat. No. 7,984,378B1 (AVAYA INC.) describes a meeting management application that permits the manipulation of meetings by groups is provided.

U.S. Pat. No. 10,438,172B2 (Clari, Inc.) describes systems and methods are provided for analyzing a history of meetings, the attendees, date of occurrence, and other content to determine the value of the meetings and the attendees.

U.S. Pat. No. 11,233,668B2 (Microsoft Technology Licensing, LLC) describes a meeting insight computing system includes a meeting evaluation machine configured to collect quality parameters from meeting quality monitoring devices.

U.S. Pat. No. 11,792,028B1 (ASANA, INC.) describes systems and methods to link meetings with units of work of a collaboration environment.

U.S. Pat. No. 11,282,036B1 (Asana, Inc.) describes systems and methods for generating an agenda for a group meeting.

U.S. Pat. No. 11,551,186B2 (Asana, Inc.) describes systems and methods for generating an agenda for a one-on-one meeting.

WO2019162958A1 (SOHRAB, Hanif) provides a device and method for recording notes based on plurality of inputs including but not limited to voice, text, image, video and capturing meeting conversations, preparing minutes of meetings, organizing data, files etc.

The present invention is directed towards providing improved management of meetings, particularly in terms of their initial organization and providing feedback afterwards.

### SUMMARY OF THE INVENTION

We describe a meetings management engine comprising digital data processors and communication interfaces, wherein the data processors are configured to:
maintain a predefined meetings definition file and a predefined meetings scoring quality file for meetings between an advisor and another party, and
manage and monitor meetings according to said files to provide for each meeting:
   a score value,
   a recording of the meeting, and
   data defining actions arising from the meeting;
provide a notification system for delivering notifications of said score values and actions.

In some preferred examples, the processors are configured to create and maintain as the predefined meetings definition file objects in a containment structure, each object related to an aspect of a meeting, and said files comprise linked objects.

In some preferred examples, the processors are configured to maintain a meetings object for a plurality of meetings and for each meeting there is a linked sequence of the following objects in containment order:
an individual meeting object,
an agendas object,
an object for each agenda,
a topics object,
an object for each topic,
conversation starters,
an object for each conversation starter,
a conversation area object,
a questions object, and
an object or each question.

In some preferred examples, the processors are configured to display communication hardware resources for conducting a meeting whenever a meeting agenda, topic, conversation starter and conversation area is displayed to the advisor and another party.

In some preferred examples:
a meetings definition file contains 1 to N meeting objects, and each meeting object contains 1 to N topic objects, with each topic object containing 1 to N conversation starters and each conversation starter object contains one conversation area object; and the conversation area object is configured to define any type of conversation area, in which the objects attached to each conversation area object are attached via an items array within the conversation area object and said items array can take 1 to N items, with each item stored as a string value of a stringified JSON object that represents the configuration of that particular item and can only be interpreted and displayed at runtime.

In some preferred examples, the processors do not define a structure of the item object such that each conversation area is configurated uniquely and has a different set of fields within it for each conversation area.

In some preferred examples, data processors are configured to provide a conversation area interface to provide a configuration view and a runtime view that can be dynamically added to the system.

In some preferred examples, the processors are configured to provide a meeting record generator to apply each captured conversation area to a timeline, and to generate a record representing the meeting items on the timeline, and to generate a quality score and compliance score for the meeting record.

In some preferred examples, the processors are configured to record information about some or all of the following:
parties attending the meeting,
time the meeting is started,
a time that each agenda, topic, conversation starter and conversation area is started and ended,
time the meeting ended,
total duration of the meeting,
a quality score of the meeting,
a compliance score of the meeting,
notes taken during the meeting,
actions triggered during the meeting.

In some preferred examples, the processors are configured to automatically trigger actions based on the conversation areas covered in the meeting and the questions answered within each conversation area.

In some preferred examples, the processors are configured to trigger actions in a timeframe prior to them being due.

In some preferred examples, the processors are configured to automatically trigger actions categorized as one or more of:
meeting-preparation actions,
during-meeting actions, which should happen before a meeting ends, and
after-meeting actions.

In some preferred examples, the processors are configured to generate notifications associated with each action item whenever an action item is due, overdue and complete, and to generate a meeting coverage map for any required time period for a set of meetings held by an advisor or team of advisors.

In some preferred examples, the processors are configured to categorize the conversation areas into a category, including a category of asking questions for client discovery;
advising, educating or showing; and
talking and asking about risk.

In some preferred examples, the processors are configured to automatically generate actions linked with an associated meeting object, and to generate and display said actions in real time during a meeting.

In some preferred examples, the processors are configured to automatically determine if an action item requires manual confirmation from a party before the action item can be processed.

In some preferred examples, the processors are configured to create and maintain as the meetings scoring quality definition file objects in a containment structure, each object related to an aspect of a meeting, and said files comprise linked objects.

In some preferred examples, the processors are configured to maintain a meetings object for a plurality of meetings and for each meeting there is a linked sequence of the following objects in containment order:
an individual meeting object,
an agendas object,
an object for each agenda,
a topics object,
an object for each topic,
conversation starters,
an object for each conversation starter,
a conversation area object,
a questions object, and
an object for each question.

In some preferred examples, the processors are configured to use the quality score definition file to calculate a quality score for each meeting, the quality score being a measure of the amount of coverage that the advisor achieved in the meeting.

In some preferred examples, the processors are configured to provide a quality score limit for each meeting in the meetings definition file and to calculate if the quality score is equal or greater than the quality score limit.

In some preferred examples, the processors are configured to provide in the quality score definition file which conversation starter, conversation area, and questions within a conversation area should be answered for calculating a compliance score and if the meeting can be said to be compliant.

In some preferred examples, the processors are configured to generate a meeting coverage map for a set of recorded meetings for a specific time period and/or advisors and/or other parties; wherein the meeting coverage map indicates the number of meetings held, the number completed within the predefined quality score limits, and the coverage level for each agenda, topic, conversation starter and conversation area within the meeting.

In some preferred examples, the processors are configured to provide a synchronization server arranged to follow in real-time a first party's instance of the meetings hub engine that is actively running a meeting.

In some preferred examples, the synchronization server comprises an interface to provide tracking information of a meeting progress.

In some preferred examples, the synchronization server comprises a web server that allows two separate meetings engine instances when being used to run a meeting between master and slave parties such as an advisor and a client, and wherein a separate notetaker user is also involved in the meeting to connect to each other, in which there are master and slave instances for the master and slave parties and a notetaker instance for the notetaker.

In some preferred examples, the synchronization server is configured to:
send a unique session object to the first instance,
the master instance uses the session object to poll the synchronisation server to be notified when the notetaker instance connects to the synchronisation server for this meeting,
when the notetaker instance makes a connection request the synchronisation server sends a session object to the notetaker instance,
receive event updates from the master instance session object, make the event updates available to the notetaker instance when the notetaker instance polls the synchronisation server,
make the event updates available to the slave instance in response to requests from the slave instance,
receiving, and acting upon, a request from the master instance to end the meeting, and closing further requests from the notetaker instance and the slave instance.

In some preferred examples, the processors are configured to, during initialization, create an instance of an action centre rules engine to determine if any action associated with the meetings definition file is triggered when the meetings engine is required to detect if any specific action is triggered during the various meeting states in which a meeting can exist, including meeting preparation, run, wrap-up and follow-up.

In some preferred examples, the action centre rules engine has a key interface method which accepts key objects including one or more of: meeting Status, user, client and action; and the rules engine is configured to verify if an action's rule attached to the action object should be triggered based on the meeting status.

In some preferred examples, the processors are configured to maintain a client object for the meeting; and the client object contains client details; and wherein an action's rule states that the rule can only be fired if a client user meets pre-defined parameter values.

In some preferred examples, the processors are configured to provide an unstructured data interpreter to automatically interpret unstructured text in communications between parties and automatically convert this unstructured data into a structured meeting definition that conforms to the meetings definition file.

In some preferred examples, said interpreter is configured to automatically scan information and feed into it by extracting key points to be discussed or questions to be asked and answered in an upcoming meeting and convert that data into a set of agenda items, topics, conversation starters and conversation areas, and to automatically assign a specific conversation area to the conversation starter, in which the interpreter scans the unstructured meetings text for key words that indicate which conversation area bests matches the context of the text scanned.

### DETAILED DESCRIPTION OF THE INVENTION

The invention will be more clearly understood from the following description of some embodiments thereof, given by way of example only with reference to the accompanying drawings in which:

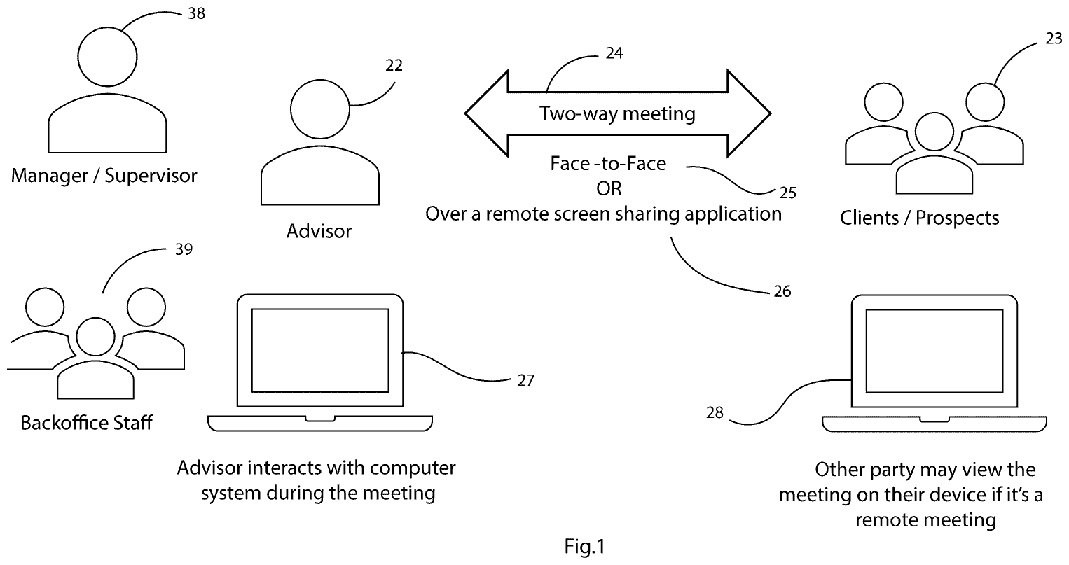

FIG. 1 is a diagram illustrating elements used during a meeting between an advisor and other party, either face-to-face or remotely over a screen-sharing application;

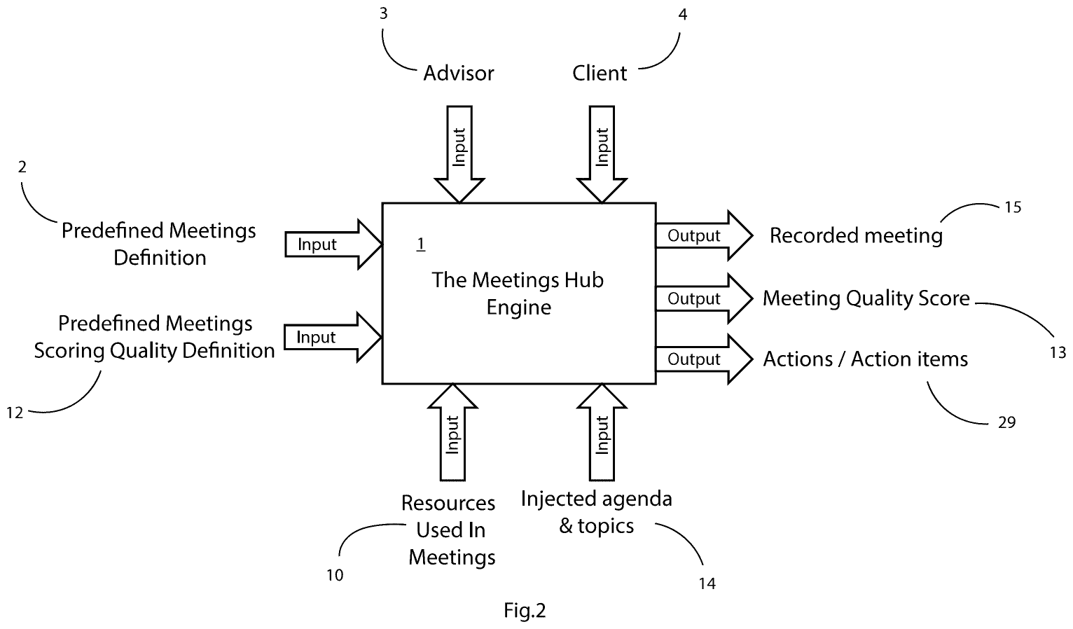

FIG. 2 is a flow diagram showing the major components of a meetings hub engine system of the invention;

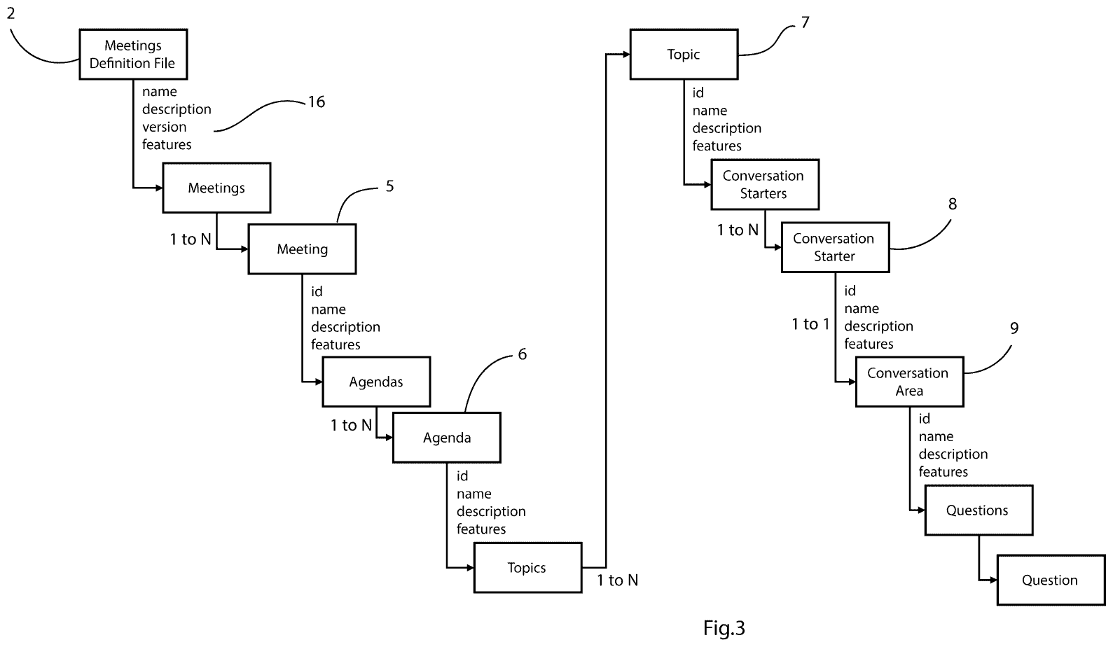

FIG. 3 is a block diagram showing a high-level meetings definition file format used by the meetings hub engine system of the invention;

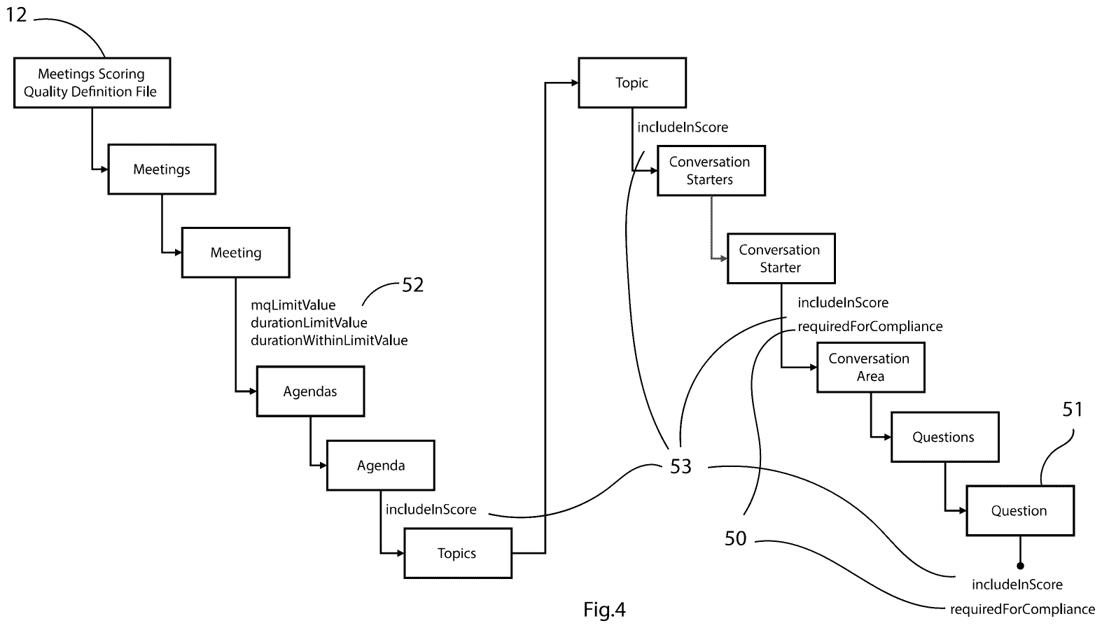

FIG. 4 is a block diagram showing a high-level meeting scoring definition file format used by the meetings hub engine system;

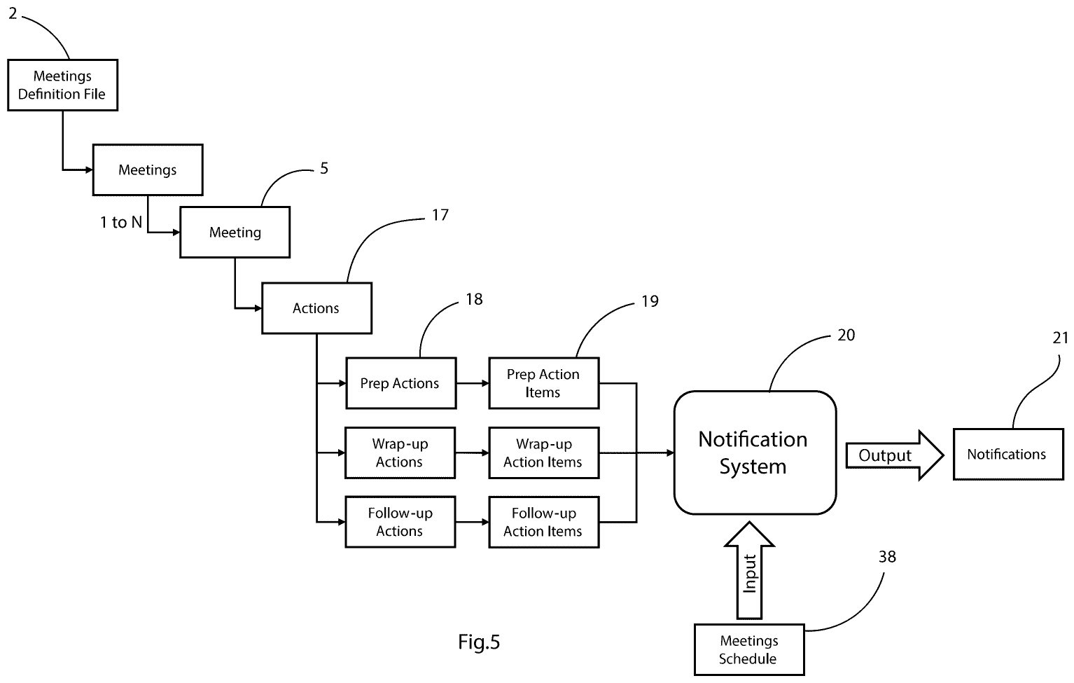

FIG. 5 is a diagram showing the actions, action items and notification system used by the meetings hub engine system;

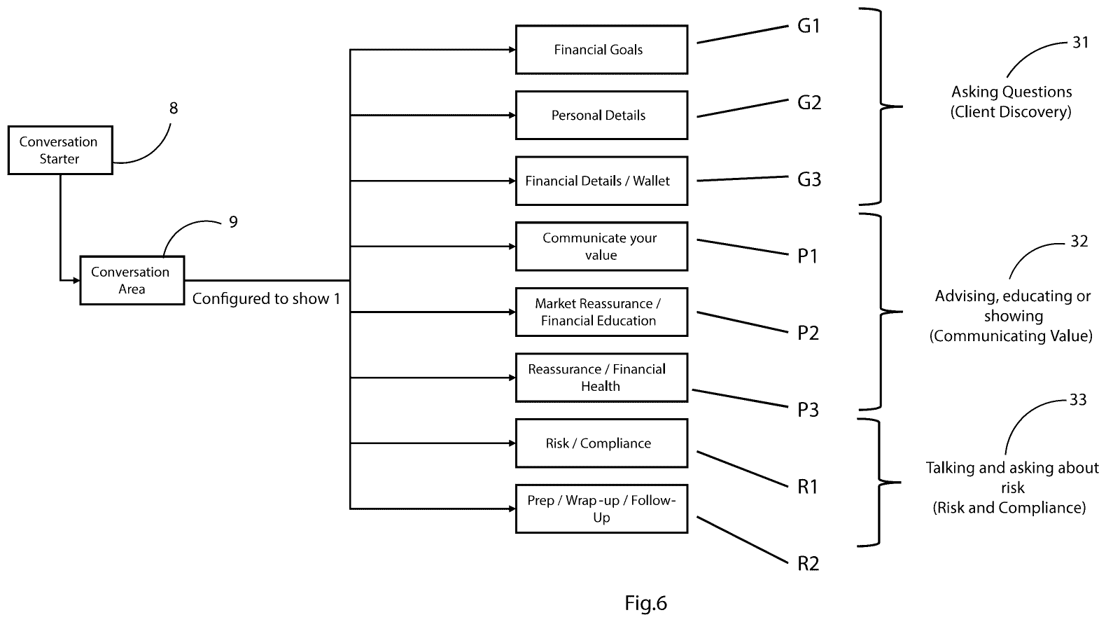

FIG. 6 is a flow diagram showing the conversation area types available for each conversation area within the system for specific financial advice meetings managed by the system;

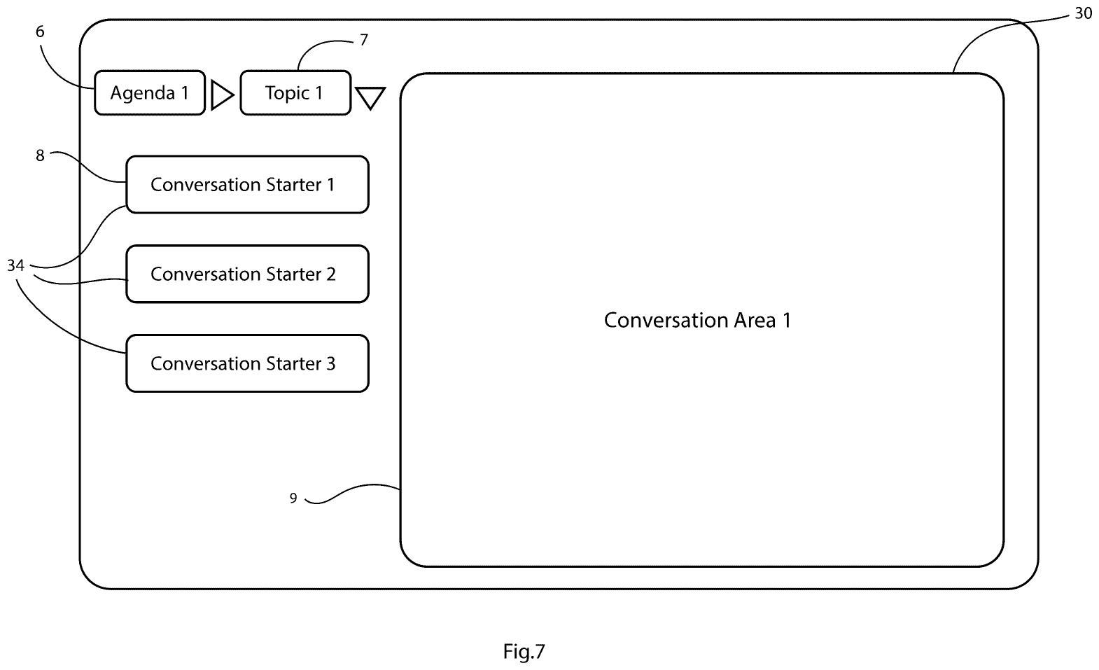

FIG. 7 is a diagram showing the presentation on screen of an agenda, topic, conversation starter and conversation area;

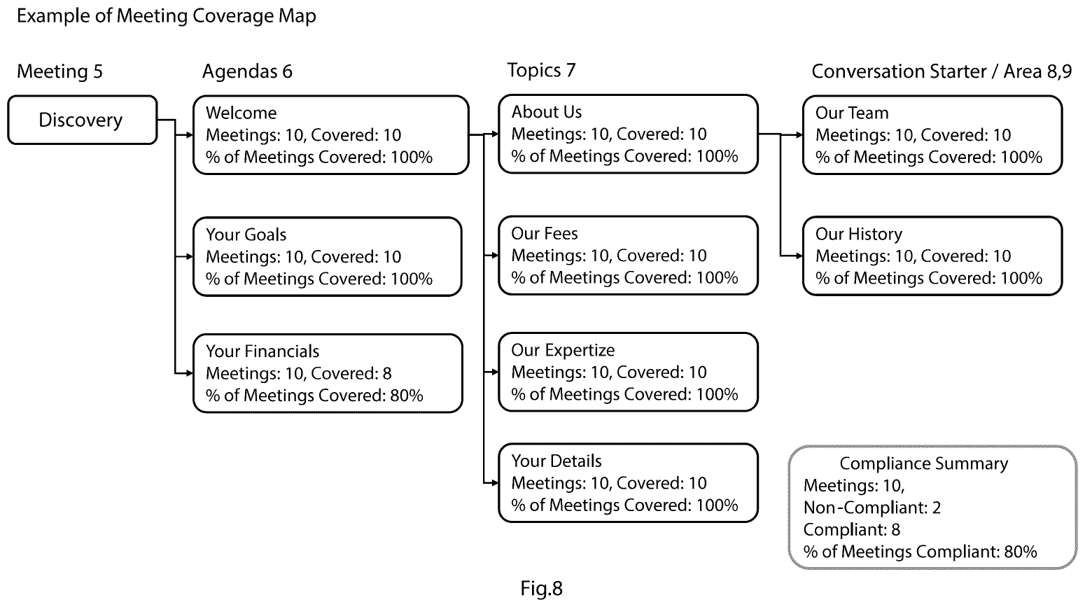

FIG. 8 is a sample of a meeting coverage map generated by the meetings hub engine system;

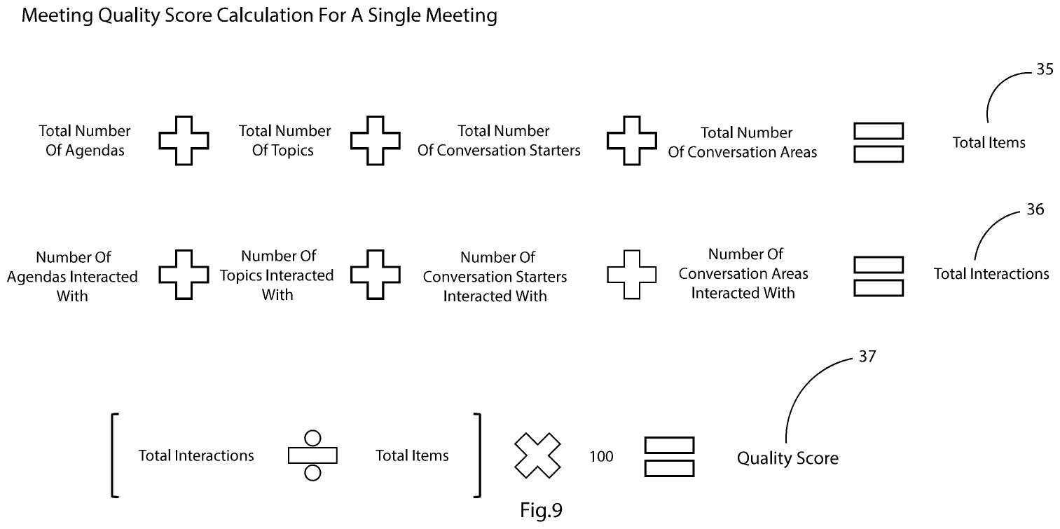

FIG. 9 is a sample meeting quality score calculation for a single meeting recorded by the meetings hub engine system;

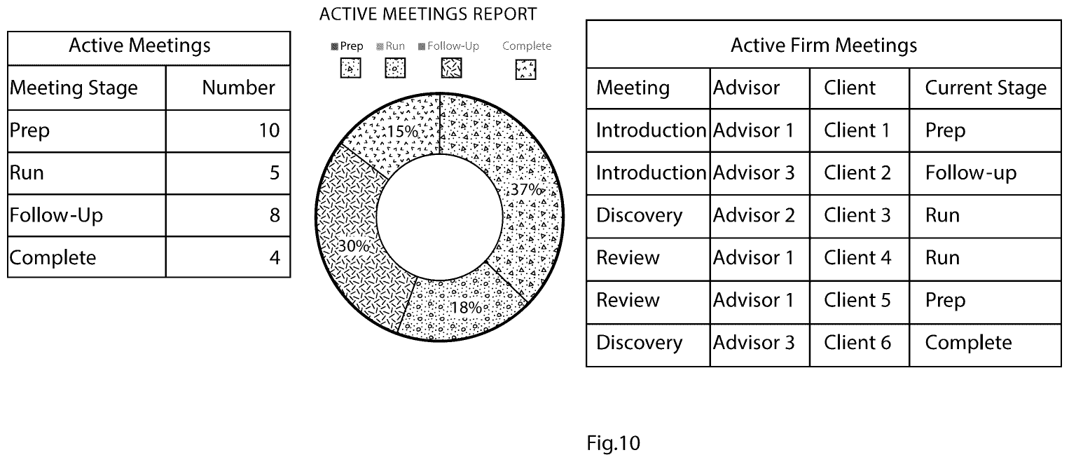

FIG. 10 shows some examples of work reports based on the system measuring the status of action items within the system;

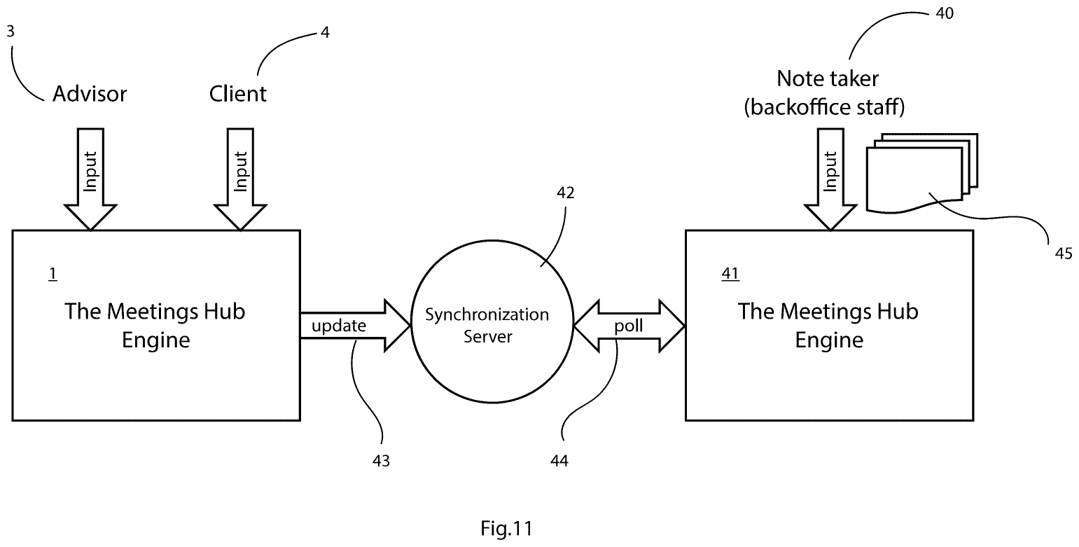

FIG. 11 is a block diagram showing a meetings hub synchronization server linking separate instances of the meetings hub engine;

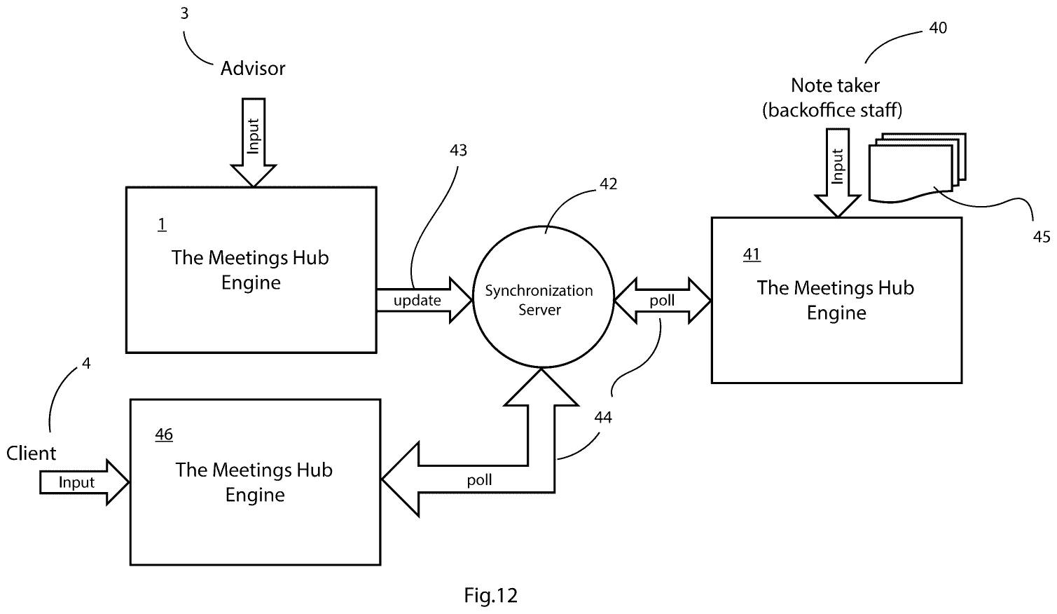

FIG. 12 is a block diagram showing a meetings hub synchronization server linking separate client, note-taker and advisor instances;

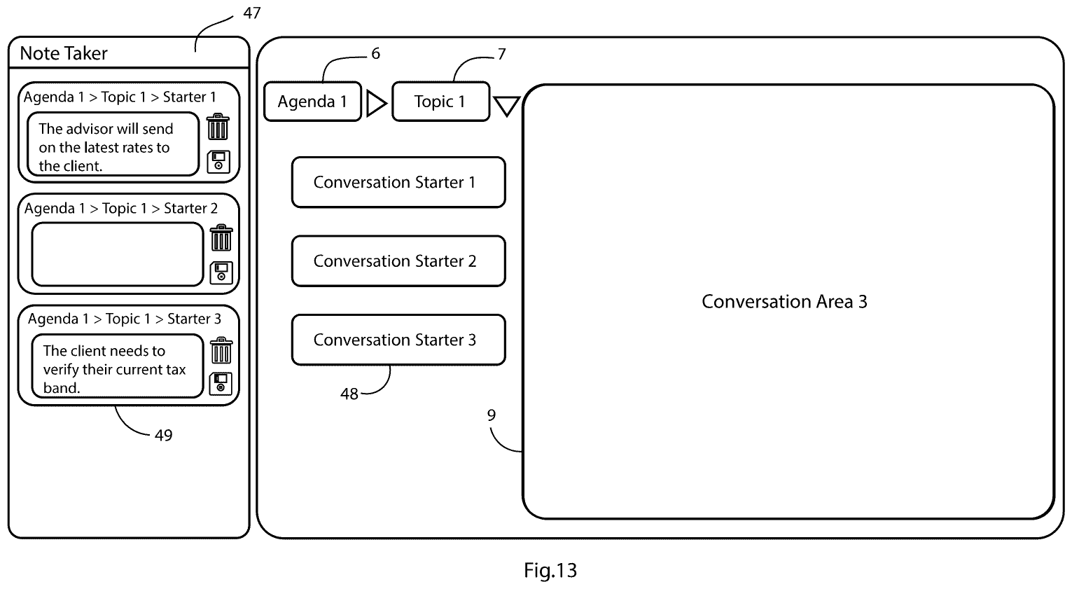

FIG. 13 is a diagram showing an additional note-taker panel when connected using the synchronization server; and

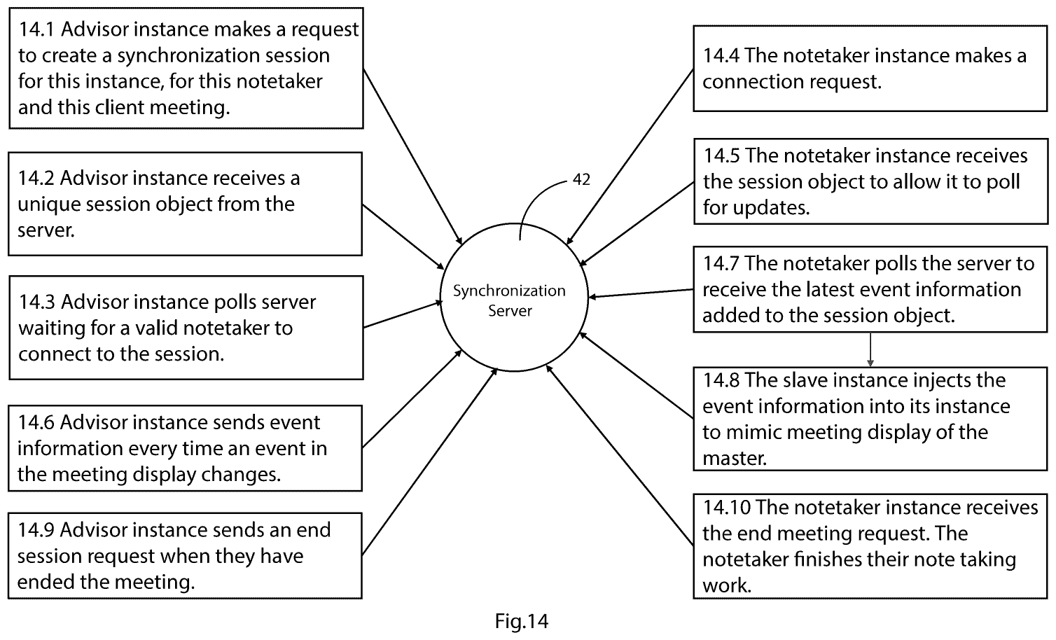

FIG. 14 is a flow diagram illustrating major steps in management of a meeting, particularly the manner in which the synchronisation server interfaces with objects to be updated

The invention relates to designing, organizing, personalizing, managing, running and scoring financial advice person-to-person or remote meetings. Examples are meetings such as an introduction meeting, discovery meeting and review meeting held between a financial advisor or broker and a new prospect or client of that advisor.

The system (or “engine”) of the invention automatically comprehensively arranges the structure, framework and definition of meetings in terms of the agendas, topics, conversation starters and conversation areas that must be covered in these meetings. The system also enables substantial customization by the user and providing a detailed record of what was actually covered in the meeting for tracking and reporting purposes.

The engine comprises digital data processors in any of the well-known hardware arrangements in a server, desktop, or laptop computer for example. The invention may take the form of a software storage medium sorting executable code for digital data processors to implement the functions of a system of the invention.

Referring to FIGS. 1 to 4 a meetings hub engine system 1 takes an input of predefined sequences of meetings 2 that a financial advisor 3 will have with their clients 4. The input 2 defines each meeting 5 with a sequence of agenda items 6. Each agenda item 6 can then have 1 to N agenda topics 7 with each topic 7 being made up of 1 to N conversation starters 8. Each conversation starter has a conversation area 9 that is covered in the meeting by the advisor. The system may associate financial advisor specific content or resources 10 such as branding, colours, images, video, questions, text and links to other systems with each conversation starter. The system when running the meeting can automatically score 13 each meeting for meeting quality based on the coverage of the meeting to the defined input 2 and scoring quality definition 12. The system is also configured to inject (14) new agenda and topics before the start of a meeting, if required to be discussed by the advisor and client. The engine can generate a complete recording 15 of the meeting when it's completed by the advisor. It can also generate actions, and their action items 9 based on the events triggered during the meeting.

The meetings hub engine system takes a predefined definition of meetings, their scoring definition, their resources and allows an advisor and another party to run a meeting and to automatically generate a recording of the meeting, measure the meeting recorded for quality and compliance and trigger actions and their action items within the meeting.

The system 1 is configured for organizing, managing, running and scoring the financial advice person-to-person or remote meetings. The advisor can work independently for themselves or be part of a firm of wealth advisors. The advisor uses the system during their meetings to help organize exactly which agenda items, topics, conversation starters and conversation areas get shown and discussed to the other party. The system automatically records any meetings defined and used during a meeting to provide a detailed record of what was covered during the meeting, advantageously providing immediate feedback to the user or supervisor of what actually happened during the meeting in terms of the areas covered in the meeting by the direct use of the engine in a meeting. The engine advantageously provides immediate feedback as to whether the meeting has been compliant i.e. have all areas within the meeting that were required to be shown and interacted with been completed. The engine also advantageously provides immediate feedback as to whether the meeting was a good quality or bad quality meeting in terms of covering all areas within the meeting that should be included in a quality meeting.

The language around creating and running business meetings is reasonably standard today. The majority of business people, no matter which industry they are in, when preparing a meeting will create an agenda for the meeting and topics to discuss for each agenda item in the meeting. The invention takes these normalized ideas and provides an advantageous format in which a sequence of meetings can be predefined and used as input for organizing, managing, running and scoring a meeting.

FIG. 1 shows an advisor 22 and clients or new prospects 23 having a meeting either face-to-face or over a remote screen-sharing application using the advisor's computer system 27, typically a laptop or desktop computer on which the invention runs. The advisor 22 either works independently or is part of a firm. If they are part of a firm, then they are likely to have a manager or supervisor 38, who is responsible for ensuring the advisor is having quality and compliant meetings with the firm's clients and prospects 23. The advisor 22 may also have some back-office staff 39 to help them organize and manage their meetings.

FIG. 2 is a block diagram showing the components of the system. An advisor computer system 27 has an instance of software of the system 1. The engine 1 takes as input a predefined meetings definition file 2 that provides details of the sequence of meetings the system supports and which the engine must operate against when the advisor 3 runs a meeting with a client 4 on their computer system. The use of the predefined meetings definition file 2 is advantageous as it allows each meeting to be repeatable from one advisor to another, particularly in a firm with a large number of advisors.

The engine 1 also takes as input a predefined meetings scoring quality definition file 12 to allow the engine 1 to score the meeting as it's being run. Attached to each element in the meetings definition file 2 are resources 10 used in the meetings. These resources are items such as images, videos, questions and text that get displayed to the advisor and client by the system 1 at certain points in the meeting as the advisor clicks through display components of the system 1. Before a meeting is started by the advisor 3, they can inject new agenda items and topics 14 into the meetings definition file specific to that meeting. This is advantageous as it allows for a level of hyper-personalization of the meeting, in that agenda items and topics specific to just that client 4 can be shown and recorded in that meeting. The engine 1 during the running of an actual meeting can output a meeting quality score 13 for the meeting. The engine 1 during the running of a meeting can trigger certain actions 29 and their action items (the granular tasks associated with the action). These actions are part of the predefined meetings definition file 2 and only get triggered if certain events within the meeting have been met. Examples of actions include downstream updates to other systems e.g. CRM, financial planning (which may be automatic integrations) as well as client inputs such as tax returns, financial statements etc. This is advantageous as it allows the system to manage the work associated with meetings in the preparation, wrap-up and follow-up of meetings.

When the meeting is finished by the advisor 3, then a full recording 15 of all the events (agenda items, their topics, their conversation starters and corresponding conversation areas, with the questions asked and answered) that took place in the meeting is available, along with all the actions and action items 29 triggered by the meeting and the quality score 13 of the meeting. This is advantageous as it allows the system 1 to build a complete coverage map of all meetings held within the system.

FIG. 3 is a block diagram showing the format of the meeting definition file 2 used by system. The meetings definition file 2 is stored in JSON format, at the topmost level 16 each meetings definition file has the following name/value pairs: name, description, version, features and meetings. Features is an object that allows for additional name/value pairs to be added over time to the definition. The feature object by default contains branding information like the colour schemes and logos to use for the advisor's firm. The meetings value is an array that takes an array of meetings 5. The meetings definition file contains 1 to N meetings 5. Each meeting object 5 has the following name/value pairs: id, name, description, features and agendas. The features object for a meeting 5 can contain additional information on the meeting like text and an image to be used when displaying the meeting to the advisor 3. Each meeting can contain 1 to N agendas 6. Each agenda object 6 has the following name/value pairs: id, name, description, features and topics. The features object for an agenda 6 can contain additional information on the agenda such as text and an image to be used when displaying the agenda to the advisor 3. Each agenda contains 1 to N topics 7. Each topic object 7 has the following name/value pairs: id, name, description, features and conversation starters. The features object for a topic 7 can contain additional information on the topic such as text and an image to be used when displaying the topic to the advisor 3. Each topic contains 1 to N conversation starters 8. Each conversation starter 8 has the following name/value pairs: id, name, description, features and conversation area. The features object for a conversation starter 8 can contain additional information on the conversation starter such as text and an image to be used when displaying the conversation starter to the advisor 3. Each conversation starter 8 contains one conversation area 9. The conversation area 9 also has the following name/value pairs: id, name, description and features. The conversation area is where images, videos, questions and text are actually displayed to the advisor 3 and the client 4. This meetings definition file structure is advantageous as it provides a mechanism by which any firm's set of meetings can be predefined and provided as input into the system 1.

FIG. 7 provides an example of one embodiment of the display of this meeting file definition 2 to the advisor 3 and client 4 by the system 1. The agenda 6 is selected by the advisor 3 in the system 1, the topic 7, a child of agenda 6 is then selected by the advisor 3 in the system. In turn the system then displays all the child conversation starters 8 of the topic 7. The advisor 3, then selects the conversation starter) to display its attached conversation area 9. The conversation area 9 is displayed in an area of the system 1, known as the centre stage (30). The centre stage (30) is a large section of the system 1 display given over to display each conversation area. The centre stage 30 can also be displayed in full screen mode if required by the advisor, which is advantageous as it allows greater space for content such as financial reports or charts 3.

FIG. 6 is a block diagram that shows that the meetings hub engine associates one of the following types of conversation area 9 to a conversation starter 8 in the meeting:
G1—Financial Goals
G2—Personal Details
G3—Financial Details/Wallet
P1—Communicate your value
P2—Market Expertize/Financial Education
P3—Reassurance/Financial Health
R1—Risk/Compliance
R2—Prep/Wrap up/Follow up

Each conversation area 9 is used to display specific type of content to the advisor 3 and the client 4. For example, a communicate your value (P1) conversation area would be used to display images, videos and text to explain items to the client (4) like who the advisor is, their history, their fees and experience etc. While a financial goals (G1) conversation area would be used to display a set of questions to the client 4 about their financial goals, like at what age they hope to retire or their required average monthly income during retirement. Providing these different conversation areas is advantageous as it helps a firm to easily organize their meetings definition file and to know exactly what type of information they need to display to the client 4 at each stage of the meeting. The meetings hub engine 1 also categorizes the conversation areas into one of three categories:
Asking questions (or client discovery) 31
Advising, educating or showing (communicating value) 32
Talking and asking about risk (risk and compliance) 33.

The meetings definition file 2 allows for specific branding and colour schemes and features to configured for these category types. In one embodiment of this invention, all asking questions conversation areas have a green colour (#27AE60) hue applied to them, all advising, educating or showing conversation areas have a purple colour (#9B51E0) hue and all talking and asking about risk have a red colour (#E90909) hue applied to them. The advisor firm can customize these colours as required (for example to match their brand palette). The use of colour to distinguish these categories is advantageous as it makes it easier to the advisor 3 to recognize the type of conversation area being presented to the advisor 3 by the system 1 at any point in the meeting. The conversation starter 8 also uses this information to colour code the display buttons 34 when the system) displays the meeting to the advisor 3 and client 4.

The meetings definition file (2) allows for the creation of a meetings designer tool that one embodiment of the invention has implemented. As the structure of the meetings is clearly defined, the meetings designer tool can allow a firm to quickly and easily build out their meetings definition file. The meetings designer provides a visual map for each meeting on which the advisor can drag and drop agendas, topics, conversation starters and conversation areas on to the map to build up a visual representation of the meetings definition file.

FIG. 4 is a block diagram of the meetings scoring quality definition file 12 format that provides an additional input to the system. This is advantageous as it allows the system to automatically score each meeting for quality. The quality score of a meeting is a calculation of the total coverage of a single meeting between an advisor 3 and client 4. Every time the system displays an agenda, topic, conversation starter and conversation area and the advisor interacts with it, this is recorded as that section of the meeting being interacted with or covered. FIG. 9 shows one embodiment of the invention and how the system calculates a quality score for a single meeting. The system counts the total number of items 35 for a meeting in a meetings definition file. When a meeting has been run through the system, then the system counts the total valid interactions 36 recording for the single meeting. The quality score for that meeting is the total interactions 36 divided by the total items 35 multiplied by 100 to give the quality score as a percentage 37. If agendas and topics have been injected 14 by an advisor into a meeting, then the system will automatically adjust the total items 35 to include any injected items into the quality score for that meeting.

FIG. 4 shows that for each meeting defined in the meetings scoring quality definition file, the meeting object must have the following name/value pairs: mqLimitValue, durationLimit Value and duration WithinLimitValue 52. The mqLimit Value is a target to indicate to the system as to whether the quality score has been reached to mark the meeting as a quality meeting. For example, if a meeting had a quality score of 78% and the mqLimit Value was configured to be 75%, then the system would automatically mark the meeting as having been a quality meeting. This is advantageous as it helps the advisor's supervisor 38 to quickly filter and review only non-quality meetings if required. The durationLimitValue and duration WithinLimit Value are used together to determine if the meeting was held in a timely manner. For example, the durationLimitValue might be set at 1 hour and the duration WithinLimitValue set to 10%. Therefore, a meeting should take between 54 minutes and 66 minutes. The system automatically records the start and end time of all meetings held, therefore it can calculate if a meeting is taking the right length of time or not. This is advantageous as it helps the advisor's supervisor 38 to quickly filter and review meetings that are taking too long or too short a time. Each meeting agenda, topic, conversation starter and conversation area can also be excluded from the quality score calculation by configuring the includeInScore 53 value to false in the meetings scoring quality definition file. This is advantageous as it allows certain items to be excluded from the calculation automatically. For example, in an introduction meeting, a firm may want the initial introduction agenda and topics to be not included in the quality score calculation as they are only showing information conversation areas, so these can be excluded from the calculation by setting the includeInScore to false. While the other agendas and topics in the meeting capture information from the client and must be part of the quality score calculation. In one embodiment of the invention, the individual questions of a conversation area can be included or excluded in the total items (35) and total interactions (36), this is advantageous as it provides a much lower level of granularity to the quality score calculation.

FIG. 4 also shows that each conversation area can also be marked as requiredForCompliance 50 and that each conversation area which can have 1 to N associated questions 51, with each individual question being marked to be included in the quality score and required for compliance. This is advantageous as it allows each meeting to be scored separately for compliance.

FIG. 8 shows an example of one embodiment of the invention where the system is configured to calculate and generate a meetings coverage map for an entire set of meetings carried out for 1 to N advisors, between 1 to N clients over any given time frame but typically a month or financial quarter. This is advantageous as it gives the advisor's supervisors 38 an insight into not only the total number of meetings held in the system but also the level of overall coverage each item in the meeting is having and if any sections are being ignored or not often visited by the advisor. The meetings coverage map also includes the level of compliance for the range of meetings reported on, which is advantageous as it gives the advisor's supervisors 38 an insight to the level of compliance each advisor is obtaining with their client meetings.

FIG. 5 is a block diagram showing in one embodiment of the meetings definition file 2 that each meeting 5 can have an actions 17 array attached to each meeting definition. A meeting 5 can have 1 to N actions 17 attached to it. These actions 17 are categorized into three action groups 18:
Prep actions
Wrap-up actions
Follow-up actions

Each action can have 1 to N action items 19 attached to it. If an action 18 is triggered by the system, then all the attached action items with it are triggered by the system. Prep actions are defined by the system as actions that must take place before the meeting starts. For example, a prep action might be sending an agenda of the meeting to the client a week before the meeting is scheduled or creating a CRM record of the client if they aren't already in the CRM system. Wrap-up actions are defined by the system as actions that must take place before the meeting ends between the advisor 3 and the client 4. For example, a wrap-up action might be to get confirmation from the client 4 that they have understood the information presented to them in the meeting. Follow-up actions are defined by the system as actions that must take place after the meeting has ended. For example, a follow-up action might be to send out a document to be signed to the client 4.

Whenever the system triggers an action and its set of action items, they automatically get fed into the system's notification system 20. The notification system 20 takes as input the meeting's schedule 38. The meetings schedule (which can come from an integrated external system like Calendly™, Microsoft Outlook™ or Microsoft Bookings™) provides details of when an actual meeting is scheduled to take place. For example, advisor 3 is scheduled to meet client 4 at 9 am in 3 weeks' time. The input of the meeting schedule to the system is advantageous as it allows the notification system to send out all required notifications in a timely manner. The information is required by the notification system 20 to correctly calculate when certain notifications should be sent to various actors in the system, these actors include the advisor, their supervisors 38, their back-office staff 39 and their clients 23. For example, an action might be to send a copy of the meeting agenda to the client 4, seven days before the meeting is due. The notification system 20 will automatically send the notification 21 to the advisor 3 and/or their back-office staff 39 to complete this action item. In one embodiment of the system, it provides an interface to the advisor 3 and their back-office staff 39 to update the status of these action items as complete or some other status. The notification system 20 is configured to also send notifications when action items are over-due and haven't been completed in a timely manner. The notification system 20 can also be configured to send out notifications when action items are complete.

Each action item in the system 1 has a status field, this status field is updated by the advisor 3 or their back-office staff 39. The status field in one embodiment of the system has one of the following states: Open, Not started, In progress, Complete, On hold and Cancelled. The system can automatically generate various work reports for the advisor 3 and their supervisor 38. FIG. 10 shows some examples of work reports based on the system measuring the status of action items within the system. The system also understands how to categorize 18 the various action items into the meeting stages: prep, run, follow-up and complete as shown in FIG. 5.

### Containment Structure

By providing a containment structure for the meetings and the objects within that structure the system can be constrained to ensure that only the elements defined in the meeting are covered in the meeting and that the meetings hub engine can only respond and react in a prescribed way through what is defined in the files.

The file structures illustrated in FIGS. 3 and 4, are at an implementation level types of objects as follows: A firm can have 1 to N meeting objects, with each meeting object made up of 1 to N topic objects, with each topic object made up of 1 to N conversation starters and each conversation starter object can have 1 conversation area object. However, a conversation area object can be used to define any type of conversation area, in one embodiment of the invention eight different conversation areas are provided by default but additional conversation areas can be added if required as the objects attached to each conversation area object are attached via an items array (this is where questions as shown in FIG. 3 are stored) within the conversation area object. This items array can take 1 to N items, with each item stored as a string value of a stringified JSON object that represents the configuration of that particular item and can only be interpreted and displayed at runtime. The system does not define the structure of the item object on purpose as each conversation area will be configurated in its own unique way and will have a different set of fields within it for each conversation area defined to be used by the system. In one embodiment of the invention, new conversation areas could be added to the system, with their own unique set of items and fields within each item by implementing the conversation area interface. The new conversation area must provide a configuration view and a runtime view that can be dynamically added to the system.

In one embodiment of the invention the meetings hub engine can take unstructured meetings text in terms of emails or text documents sent between parties that outlines what will be discussed in the meeting and automatically convert this unstructured data into a structured meeting definition that conforms to the meetings definition file. The meetings hub engine is configured to automatically scan information (such as text in an email or a text document) and feed into it by extracting key points to be discussed or questions to be asked and answered in an upcoming meeting and convert that data into a set of agenda items, topics, conversation starters and conversation areas. Based on the type of question being asked the meetings hub engine unstructured data interpreter can automatically assign a specific conversation area to the conversation starter. The system has eight different conversation areas it can select from: G1, G2, G3, P1, P2, P3, R1 and R2 as described previously, with each area specific to the type of question or information required to be answered during the meeting. The interpreter scans the unstructured meetings text for key words that indicate which conversation area bests matches the context of the text scanned. If the interpretation is incorrect, it can be fixed and changed in the design component of the meetings hub engine. The meetings hub definition file is not made available at the runtime of meetings until it has been verified by the firm or manager and published from the meeting hub engine design tool.

The dynamically created meeting definition file can then become the starting point for a complete meeting definition for a particular type of meeting, for example an annual review meeting or a new client discovery meeting. A major advantage of providing a complete meeting definition file for a meeting is that running the meeting becomes consistent between different parties such as advisors and clients. The meeting is repeatable and recordable in terms of agenda items, topics, conversation starters and conversation areas covered any meeting between an advisor and their client. All meetings held by an advisor with their client using the meetings hub engine is now repeatable and recordable. Each agenda item, topic, conversation area and starter in the meeting definition file has a unique id. When a meeting is running in the meetings hub engine with the meeting definition file, the meeting is recorded by capturing every interaction between the advisor and client and the unique id of each element of the meeting definition file triggered during the meeting, it also records the time stamp of each element triggered in the meeting. This data is then stored in a relational database to allow for detailed analysis at a later date. The fact that meetings are recordable and repeatable has the added benefit of ensuring compliance in that a firm or manager knows exactly what was covered in each meeting and what wasn't. They also know the time spent on and between each conversation area. This is advantageous for example, if a conversation area is used to explain a very technical aspect of financial advice, a manager can analyse the recorded meeting to determine if enough time was spent on the conversation area to correctly explain the advice to the client. The meetings definition file is held separately from the recorded meeting as an added security precaution. The recorded meeting is a sequence of unique ids, timestamps and user ids which without the meetings definition file is meaningless to any third party.

A conversation area like a G1—Financial Goals where it might display a question like at what age a client wishes to retire? Specific actions may have been setup within the meetings engine system based on the answer to this conversation area question. For example, if the client wished to retire at the younger age (i.e. less than 55 years old) and an action had been setup in the system to trigger when the answer to this question was to retire younger than 55 years old, then the action center rules engine built into the meetings engine would trigger this rule and its associated action.

The system when initialized creates an instance of the action center rules engine, this action center rules engine is used to determine if any action associated with the meetings definition file is triggered when the meetings engine system is required to detect if any specific action is triggered during the various meeting states in which a meeting can exist: prep, run, wrap-up or follow-up of a meeting. The action center rules engine has a key interface method called isActionForMeetingEventsTriggered which accepts 4 key objects: meetingStatus, user, client and action. The rules engine can then verify if an action's rule (which is attached to the action object) should be triggered based on the meeting status, the user running or carrying out the work associated with the meeting and the client involved in the meeting. The client object contains details on who the client is like their age, gender, type, segmentation and what content in the meeting the client has been shown or interacted with. This content is held within the client object and details for each meeting like what agendas, topics, conversation starters and the content within the conversation areas the client has been shown or interacted with. If an action's rule states that the rule can only be fired if the user is of a specific type and the client must be of a particular segmentation and the client must have interacted with a particular section of a conversation area, like they indicated that the wanted to retire between 65 and 70, then the action center rules engines can determine that by querying the objects passed to it and tested for those specific conditions.

That action will then be automatically fired during the meeting and displayed in the wrap-up or follow-up pages of the meetings display system. Actions can have 1 to N action items connected to them, these action items can be automatic action items such as sending an automatic email if triggered, or it might require manual confirmation from the client that the item triggered is correct and should be handled in a specific way if confirmed by the client or advisor.

It is advantageous that the meetings hub engine has the ability to automatically handle certain action items but also to interpret if an action item required manual confirmation from a party before the action item can be processed. Getting manual confirmation for certain action items to proceed is a major compliance requirement for many financial advice governing bodies.

With financial advice meetings held between an advisor and a client, there is often a third actor involved in the meeting. This third actor may be a back-office staff member 39 who sits in on the meeting, often taking notes during the meeting for the advisor. FIG. 11 in one embodiment of the invention shows a block diagram of the meetings hub synchronization server linking separate instances of the meetings hub engine. When an advisor 3, starts a meeting with a client 4 using the meetings hub engine, the advisor can switch their instance of the engine into a shared instance. This automatically connects the engine with the synchronization server 42. The synchronization server 42 starts a unique synchronization session for that advisor, client and assigned note taker (or another attendee). The note taker 40 instructs their instance of the engine to connect with the synchronization server 42. The synchronization server 42 will automatically link the two meetings hub engines together provided an active synchronization session exists for that note taker. Once the two meetings hub engines are linked, the advisor's instance will continually update 43 its meeting location, position and questions answered with the synchronization server (42). The note taker's instance 41 will continually poll 44 the synchronization server 42 for the latest meeting location, position, questions asked, and questions answered. The note taker's instance 41 will then automatically move its display to match the display of the advisor's instance. The system 41 will provide the note taker with an additional display to allow notes 45 to be taken at specific points in the meeting.

The synchronization server is a very small and fast web server that allows two separate meetings engine instances when being used to run a meeting between parties such as an advisor and a client and where a separate notetaker user is also involved in the meeting to connect to each other via https requests. One instance becomes the master connection and the other connected instance becomes the slave connection. It allows the advisor and notetaker instances to connect to each other. The synchronization server connection flow is described in FIG. 14.

The synchronization server comprises a web server that allows two separate meetings engine instances when being used to run a meeting between master and slave parties such as an advisor and a client and where a separate notetaker user is also involved in the meeting to connect to each other, in which there are master and slave instances for the master and slave parties and a notetaker instance for the notetaker.

In summary the following steps are undertaken between the synchronisation server 42, a master (advisor) meeting instance, a slave (client) meeting instance, and a notetaker meeting instance.

The synchronization server is configured to:
send (14.1, 14.2) a unique session object to the master instance, the master instance uses (14.3) the session object to poll the synchronisation server 42 to be notified when the notetaker instance connects to the synchronisation server for this meeting,
when the notetaker instance makes (14.4) a connection request the synchronisation server sends (14.5) a session object to the notetaker instance,
receive (14.6) event updates from the master instance session object,
make (14.7) the event updates available to the notetaker instance when the notetaker instance polls the synchronisation server,
make (14.8) the event updates available to the slave instance in response to requests from the slave instance,
receiving (14.9), and acting upon, a request from the master instance to end the meting, and closing further requests from the notetaker instance and the slave instance.

The advisor instance makes (14.1) a request to the synchronization server to create a synchronization session for this instance, for a selected notetaker user and a selected client meeting. The synchronization server ensures that the advisor is a valid user of the system and then the connected advisor instance becomes the master connection, and the synchronization server returns (14.2) a unique session object for the master connection to update. The advisor instance then polls (14.3) the server every 250 milliseconds waiting for a notetaker instance to make a connection.

The notetaker instance then makes (14.4) a connection request to the synchronization server, the server ensures that the notetaker is a valid user of the system and that an existing valid session exists in the server for this notetaker; if a session exists then that session object is returned (14.5) to the notetaker instance as a slave connection.

Once the master instance receives notice that the notetaker instance is now connected to the session object then the master instance can start sending event information to the synchronization server for that session. The master instance sends (14.6) any event that occurs in its meeting display to the server. These events include things like mouse clicks and keyboard entries. The notetaker instance polls (14.7) the server every 250 milliseconds to receive the latest event information added to the session object. The slave instance then injects (14.8) the event information into its instance of the meeting display to mimic the meeting display of the master.

The synchronization server only allows one unique session to exist between a specific advisor and a notetaker. No other party users can connect to an existing session and any attempt to join an existing session from an unauthorized user (either a user in the system but not assigned to the meeting by the advisor or an external unknown user) stops and closes the session immediately and prevents it from been used again. The currently connected advisor and notetaker will be informed of the connection attempt and the session will be closed immediately on their meetings hub engine instances.

In one embodiment of the system, the notetaker can then create or update notes on the meeting at specific points within the mimicked meeting that would match where the advisor would want the note to have been made. These notes when saved by the notetaker will be synchronized back to the advisor's instance and injected into the advisors meetings hub display so that the notes will also be available to the advisor if needed.

When the advisor ends (14.9) the meeting, the synchronization server is notified that the session has been ended by the master connection. The notetaker instance will then receive (14.10) this end session notification on its next poll request. Once the synchronization server 42 has informed the slave connection that the meeting has ended, it will remove the session object from the synchronization server, making any future requests to that session invalid. The notetaker instance will notify the notetaker that the advisor has ended the meeting and that the notetaker should finish any notes that they are currently working with. The notetaker instance will keep its instance of the meeting display open until the notetaker has completed their notes and only then will close their instance of the meeting display for that meeting.

FIG. 13 shows one embodiment of the note taker display 47, in the meetings hub instance. The note taker display 47 follows the meeting and as key points in the meeting are reached, the note taker can write notes in that position. For example, in FIG. 13, the advisor has positioned the display of the system on agenda 1 (6), topic 2 (7) and conversation starter 3 (48), the note taker can then take a note on this position in panel 49. The embodiment of the synchronization server 42 is advantageous as it allows the note taker to see the progress through the meeting even if they are not physically present at a face-to-face meeting between the advisor 3 and the client 4 or logged on to the remote meeting. In one embodiment of the meetings hub engine display, it contains a number of animated transitions when switching from an agenda, topic, conversation starter or conversation area. Often in remote meeting situations, the remote screen-sharing software struggles to animate these transitions smoothly, they may appear jumpy with skipped frames to the remote user. Another advantage of the synchronization server 42 is that all animated transitions and any video played in the meeting conversation area, will appear completely smooth and in full to the note taker 40 user. In one embodiment of the invention, the client could use an instance of the meetings hub engine and connect to the synchronization server in the same way as the note taker 40. This is advantageous as it means the client wouldn't have to install the remote meeting software required to observe the advisor, just login the system in their computer device's web browser. This embodiment is shown in FIG. 12.

### Summary of Advantageous Features of the Invention

The hub engine comprises:
a meeting processor configured to take a predefined meetings definition file and a predefined meetings scoring quality definition file to run any meeting between an advisor and another party,
and
a processor configured to display certain resources used in the meetings whenever a meeting agenda, topic, conversation starter and conversation area is displayed to the advisor and another party, wherein the system comprises a meeting record generator configured to apply each captured conversation area to a timeline, and to generate a record representing the meeting items on the timeline, and to generate a quality score and compliance score for the meeting record,
and
a processor configured to trigger actions associated with each meeting, whenever a meeting action is triggered, a set of action items can be fired to detail the work that an advisor, their staff and/or another party need to undertake for the various stages: the before (prep), the during (wrap-up) and the after (follow-up) of a meeting,
and
a processor configured to generate notifications associated with each action item whenever an action item is due, overdue and complete,
and
a processor that can generate a meeting coverage map for any required time period for a set of meetings held by an advisor or team of advisors.

In one embodiment, the meetings hub engine is configured to take a specific meeting definition file to be made up of:
Meetings and their list of agendas,
List of each agenda's topics,
List of each topic's conversation starters,
And each conversation starter's associated conversation area.

In one embodiment, the meetings hub engine associates one of the following conversation areas to the meeting:
G1—Financial Goals
G2—Personal Details
G3—Financial Details/Wallet
P1—Communicate your value
P2—Market Expertize/Financial Education
P3—Reassurance/Financial Health
R1—Risk/Compliance
R2—Prep/Wrap up/Follow up

In one embodiment, the meetings hub engine categorizes the conversation areas into one of three categories:
Asking questions (or client discovery)
Advising, educating or showing (communicating value)
Talking and asking about risk (risk and compliance)

To apply specific branding and colour schemes and features to these category types.

In one embodiment, the meetings hub engine is configured to allow the advisor to attach their brand colors, images, videos, questions and text to each meeting conversation area.

In one embodiment, the advisor can inject new agenda items and their associated topics, conversation starter and conversation area before the meeting starts which are not part of the original meeting definition file. For example, an advisor may see a new investment trend or tax incentive that the other party might be interested in discussing during the meeting, this new talking point can be injected into the meeting definition file before the meeting starts.

In one embodiment, the meetings hub engine is configured to take a specific meeting quality score definition file to be made up of:
Which agenda, topics, conversation starter and conversation areas need to be covered to be scored as part of a quality meeting.

The quality score definition file is then used to calculate a quality score for each meeting, the quality score being a measure of the amount of coverage that the advisor achieved in the meeting. In one embodiment, a quality score limit for each meeting in the meetings definition file is also configured and set within the quality score definition file to allow the system to calculate if a meeting recorded is a quality meeting or not i.e. if the quality score is equal or greater than the quality score limit.

In one embodiment, the quality score definition file also includes:
Which conversation starter, conversation area, and questions within a conversation area should be answered for calculating a compliance score and if the meeting can be said to be compliant.

In one embodiment, the meetings hub engine records the following as part of the meeting record:
The advisor starting or running the meeting,
The other parties attending the meeting,
The time the meeting is started,
The time each agenda, topic, conversation starter and conversation area is started and ended,
The time the meeting is ended,
The total duration of the meeting,
The quality score of the meeting,
The compliance score of the meeting,
The notes taken during the meeting,
The actions and the action items triggered during the meeting.

In one embodiment, the meetings hub engine automatically triggers the following:
The actions and the action items based on the conversation areas covered in the meeting and the questions answered within each conversation area.

These actions are categorized into one of three areas:
Meeting preparation actions, i.e. what should happen before a meeting is started like getting certain permissions or documentation from the other party.
During the meeting actions, i.e. what should happen before a meeting is ended such as agreeing a change to portfolio allocation or funds.
After the meeting actions, i.e. what should happen after a meeting has ended like sending the other party certain documentation or further information.

In one embodiment, the meetings hub engine automatically triggers notifications based on certain action items triggered by the system. These notifications can be configured to be triggered in some timeframe prior to them being due, they can also be configured to be triggered when an action item is due, late or complete.

In one embodiment, the meetings hub engine can be used to generate a meeting coverage map for a set of recorded meetings for a specific time period and/or advisors and/or other parties. The meeting coverage indicates the number of meetings held, the number completed within the predefined quality score limits, and the coverage level for each agenda, topic, conversation starter and conversation area within the meeting.

In one embodiment, the meetings hub engine can be used to generate a complete overview of the status of the work for a firm and or an advisor broken down by the various stages (preparation, running and follow-up) of a meeting. The status of each triggered action item in the system provides a complete overview of the level of work remaining or complete for any given meeting.

In one embodiment, the meeting hub engine includes a synchronization server that can be used by another back-office staff member, most often a note taker, to follow in real-time the advisor's instance of the meetings hub engine that is actively running a meeting between an advisor and a client. This note-taker instance (which instance includes other attendees not necessarily with a note-taker role, for example the attendee could be an internal auditor, a trainee etc.) follows the meeting in read-only form but does allow the note taker to attach specific notes to specific points in the meeting using their own instance of the meetings hub engine.

In one embodiment, the meetings hub engine synchronization server can be used by the client to follow in real-time the advisor's instance of the meetings hub engine that is actively running a meeting between an advisor and a client.

Components of embodiments can be employed in other embodiments in a manner as would be understood by a person of ordinary skill in the art. The invention is not limited to the embodiments described but may be varied in construction and detail.

1. A meetings management engine comprising digital data processors and communication interfaces, wherein the data processors are configured to:
maintain a predefined meetings definition file and a predefined meetings scoring quality file for meetings between an advisor and another party, and manage and monitor meetings according to said files to provide for each meeting:
a score value,
a recording of the meeting, and
data defining actions arising from the meeting;
provide a notification system for delivering notifications of said score values and actions.

2. The meetings management engine as claimed in claim 1, wherein the digital data processors are configured to create and maintain as the predefined meetings definition file objects in a containment structure, each object related to an aspect of a meeting, and said files comprise linked objects.

3. The meetings management engine as claimed in claim 1, wherein the digital data processors are configured to create and maintain as the predefined meetings definition file objects in a containment structure, each object related to an aspect of a meeting, and said files comprise linked objects; and wherein the digital data processors are configured to maintain a meetings object for a plurality of meetings and for each meeting there is a linked sequence of the following objects in containment order:
an individual meeting object,
an agendas object,
an object for each agenda,
a topics object,
an object for each topic,
conversation starters,
an object for each conversation starter,
a conversation area object,
a questions object, and
an object for each question.

4. The meetings management engine as claimed claim 1, wherein the digital data processors are configured to create and maintain as the predefined meetings definition file objects in a containment structure, each object related to an aspect of a meeting, and said files comprise linked objects; and wherein the digital data processors are configured to maintain a meetings object for a plurality of meetings and for each meeting there is a linked sequence of the following objects in containment order:
an individual meeting object,
an agendas object,
an object for each agenda,
a topics object,
an object for each topic,
conversation starters,
an object for each conversation starter,
a conversation area object,
a questions object, and
an object for each question; and
wherein the digital data processors are configured to display communication hardware resources for conducting a meeting whenever a meeting agenda, topic, conversation starter and conversation area is displayed to the advisor and another party.

5. The meetings management engine as claimed in claim 1, wherein:
the digital data processors are configured to create and maintain as the predefined meetings definition file objects in a containment structure, each object related to an aspect of a meeting, and said files comprise linked objects; a meetings definition file contains 1 to N meeting objects, and each meeting object contains 1 to N topic objects, with each topic object containing 1 to N conversation starters and each conversation starter object contains one conversation area object; and
the conversation area object is configured to define any type of conversation area, in which the objects attached to each conversation area object are attached via an items array within the conversation area object and said items array can take 1 to N items, with each item stored as a string value of a stringified JSON object that represents the configuration of that particular item and can only be interpreted and displayed at runtime.

6. The meetings management engine as claimed in claim 1, wherein:
the digital data processors are configured to create and maintain as the predefined meetings definition file objects in a containment structure, each object related to an aspect of a meeting, and said files comprise linked objects; a meetings definition file contains 1 to N meeting objects, and each meeting object contains 1 to N topic objects, with each topic object containing 1 to N conversation starters and each conversation starter object contains one conversation area object;
the conversation area object is configured to define any type of conversation area, in which the objects attached to each conversation area object are attached via an items array within the conversation area object and said items array can take 1 to N items, with each item stored as a string value of a stringified JSON object that represents the configuration of that particular item and can only be interpreted and displayed at runtime, wherein the digital data processors do not define a structure of the item object such that each conversation area is configurated uniquely and has a different set of fields within it for each conversation area; and
said digital data processors are configured to provide a conversation area interface to provide a configuration view and a runtime view that can be dynamically added to the system.

7. The meetings management engine as claimed in claim 1, wherein the digital data processors are configured to provide a meeting record generator to apply each captured conversation area to a timeline, and to generate a record representing the meeting items on the timeline, and to generate a quality score and compliance score for the meeting record, and
wherein the digital data processors are configured to record information about some or all of the following:
parties attending the meeting,
time the meeting is started,
a time that each agenda, topic, conversation starter and conversation area is started and ended,
time the meeting ended,
total duration of the meeting,
a quality score of the meeting,
a compliance score of the meeting,
notes taken during the meeting,
actions triggered during the meeting.

8. The meetings management engine as claimed in claim 1, wherein:
the digital data processors are configured to automatically trigger actions based on the conversation areas covered in the meeting and the questions answered within each conversation area,
the digital data processors are configured to trigger actions in a timeframe prior to them being due, and
the digital data processors are configured to automatically trigger actions categorized as one or more of:
meeting-preparation actions,
during-meeting actions, which should happen before a meeting ends,
and
after-meeting actions.

9. The meetings management engine as claimed in claim 1, wherein:
the digital data processors are configured to generate notifications associated with each action item whenever an action item is due, overdue and complete, and to generate a meeting coverage map for any required time period for a set of meetings held by an advisor or team of advisors, and
the digital data processors are configured to categorize the conversation areas into a category, including a category of asking questions for client discovery;
advising, educating or showing; and talking and asking about risk.

10. The meetings management engine as claimed in claim 1, wherein:
the digital data processors are configured to automatically generate actions linked with an associated meeting object, and to generate and display said actions in real time during a meeting, and
the digital data processors are configured to automatically determine if an action item requires manual confirmation from a party before the action item can be processed, and
the digital data processors are configured to create and maintain as the meetings scoring quality definition file objects in a containment structure, each object related to an aspect of a meeting, and said files comprise linked objects.

11. The meetings management engine as claimed in claim 1, wherein:
the digital data processors are configured to automatically generate actions linked with an associated meeting object, and to generate and display said actions in real time during a meeting, and
the digital data processors are configured to automatically determine if an action item requires manual confirmation from a party before the action item can be processed,
the digital data processors are configured to create and maintain as the meetings scoring quality definition file objects in a containment structure, each object related to an aspect of a meeting, and said files comprise linked objects; and
the digital data processors are configured to maintain a meetings object for a plurality of meetings and for each meeting there is a linked sequence of the following objects in containment order:
an individual meeting object,
an agendas object,
an object for each agenda,
a topics object,
an object for each topic,
conversation starters,
an object for each conversation starter,
a conversation area object,
a questions object, and
an object for each question.

12. The meetings management engine as claimed in claim 1, wherein:
the digital data processors are configured to use the quality score definition file to calculate a quality score for each meeting, the quality score being a measure of the amount of coverage that the advisor achieved in the meeting, and
the digital data processors are configured to provide a quality score limit for each meeting in the meetings definition file and to calculate if the quality score is equal or greater than the quality score limit.

13. The meetings management engine as claimed in claim 1, wherein the digital data processors are configured to provide in the quality score definition file which conversation starter, conversation area, and questions within a conversation area should be answered for calculating a compliance score and if the meeting can be said to be compliant.

14. The meetings management engine as claimed in claim 1, wherein the digital data processors are configured to generate a meeting coverage map for a set of recorded meetings for a specific time period and/or advisors and/or other parties; wherein the meeting coverage map indicates the number of meetings held, the number completed within the predefined quality score limits, and the coverage level for each agenda, topic, conversation starter and conversation area within the meeting.

15. The meetings management engine as claimed in claim 1, wherein:
the digital data processors are configured to provide a synchronization server arranged to follow in real-time a first party's instance of the meetings hub engine that is actively running a meeting, and
the synchronization server comprises an interface to provide tracking information of a meeting progress.

16. The meetings management engine as claimed in claim 1, wherein:
the digital data processors are configured to provide a synchronization server arranged to follow in real-time a first party's instance of the meetings hub engine that is actively running a meeting,
the synchronization server comprises an interface to provide tracking information of a meeting progress,
the synchronization server comprises a web server that allows two separate meetings engine instances when being used to run a meeting between master and slave parties such as an advisor and a client, and wherein a separate notetaker user is also involved in the meeting to connect to each other, in which there are master and slave instances for the master and slave parties and a notetaker instance for the notetaker, and
the synchronization server is configured to:
send a unique session object to the first instance,
the master instance uses the session object to poll the synchronisation server to be notified when the notetaker instance connects to the synchronisation server for this meeting,
when the notetaker instance makes a connection request the synchronisation server sends a session object to the notetaker instance, receive event updates from the master instance session object,
make the event updates available to the notetaker instance when the notetaker instance polls the synchronisation server,
make the event updates available to the slave instance in response to requests from the slave instance,
receiving, and acting upon, a request from the master instance to end the meeting, and closing further requests from the notetaker instance and the slave instance.

17. The meetings management engine as claimed in claim 1, wherein:
the digital data processors are configured to, during initialization, create an instance of an action centre rules engine to determine if any action associated with the meetings definition file is triggered when the meetings engine is required to detect if any specific action is triggered during the various meeting states in which a meeting can exist, including meeting preparation, run, wrap-up and follow-up,
the action centre rules engine has a key interface method which accepts key objects including one or more of: meeting Status, user, client and action; and
the rules engine is configured to verify if an action's rule attached to the action object should be triggered based on the meeting status.

18. The meetings management engine as claimed in claim 1, wherein:
the digital data processors are configured to, during initialization, create an instance of an action centre rules engine to determine if any action associated with the meetings definition file is triggered when the meetings engine is required to detect if any specific action is triggered during the various meeting states in which a meeting can exist, including meeting preparation, run, wrap-up and follow-up,
the action centre rules engine has a key interface method which accepts key objects including one or more of: meeting Status, user, client and action; and
the rules engine is configured to verify if an action's rule attached to the action object should be triggered based on the meeting status, and
the digital data processors are configured to maintain a client object for the meeting; and the client object contains client details; and wherein an action's rule states that the rule can only be fired if a client user meets pre-defined parameter values.

19. The meetings management engine as claimed in claim 1, wherein the digital data processors are configured to provide an unstructured data interpreter to automatically interpret unstructured text in communications between parties and automatically convert this unstructured data into a structured meeting definition that conforms to the meetings definition file.

20. The meetings management engine as claimed in claim 1, wherein:
the digital data processors are configured to provide an unstructured data interpreter to automatically interpret unstructured text in communications between parties and automatically convert this unstructured data into a structured meeting definition that conforms to the meetings definition file, and said interpreter is configured to automatically scan information and feed into it by extracting key points to be discussed or questions to be asked and answered in an upcoming meeting and convert that data into a set of agenda items, topics, conversation starters and conversation areas, and to automatically assign a specific conversation area to the conversation starter, in which the interpreter scans the unstructured meetings text for key words that indicate which conversation area bests matches the context of the text scanned.
